(19) United States
(12) Patent Application Publication
(10) Pub. No.: US 2026/0225281 A1
(43) Pub. Date: Aug. 6, 2026

(54) METHOD FOR FINISHING A FURNITURE ITEM AND MACHINE TOOL

(71) Applicant: TECNO LOGICA S.R.L., Spresiano (IT)

(72) Inventor: Mirko PIASENTIN, Spresiano (IT)

(21) Appl. No.: 19/150,545

(22) PCT Filed: Jan. 11, 2024
(86) PCT No.: PCT/IB2024/050295

§ 371 Date: Jul. 24, 2025

(30) Foreign Application Priority Data
Jan. 24, 2023 (IT) 102023000001026

(51) Int. Cl. B27M 3/18; B27D 5/00; B27K 5/02

(52) U.S. Cl. CPC B27M 3/18; B27K 5/02; B27D 5/003

(57) ABSTRACT

A method is described for finishing a furniture item comprising or consisting of: a top panel, a bottom panel, and two side walls assembled to form a shell delimiting a compartment with an access opening; the top panel, the bottom panel, and the two side walls each having a front edge in the assembled furniture item, such front edges forming the perimeter of the opening and having a substantially flat surface;

Said surface of the front edges of the top panel, bottom panel, and side walls are decorated or colored by running over it—or passing over it—with a printing head to deposit a dye there.

### TECHNICAL FIELD

The present invention refers to a method and a numerical control machine tool for decorating or coloring a furniture item.

### BACKGROUND

In the production of customized furniture, one variable is the color, in particular the color of the front edges of the furniture (see FIG. 1). A furniture item 10 consists of, or comprises: a top panel 12 parallel to a bottom panel 14, and two side panels 16-1, 16-2 parallel to each other. The panels 12, 14, 16-1, 16-2 are assembled to delimit a parallelepiped box-shaped compartment 18 with an access opening; and have a respective front edge 12b, 14b, 16b which constitutes the perimeter of the opening and is colored as a customization of the furniture item. For this purpose, the panels 12, 14, 16-1, 16-2 are currently individually colored on the edges 12b, 14b, 16b before assembly and then stored in a warehouse with different codes. According to the production order, the customized panels are then taken from the warehouse and directed to the assembly lines of the furniture item 10. However, this solution involves a very high number of items to be managed in the warehouse because each color and shape variant of panel must be produced in advance and then stored, generating high costs and management complications.

Some manufacturers, instead, manually apply strips of colored material on the edges 12b, 14b, 16b of the assembled furniture item 10 after having torn the original strips, but the quality of the furniture deteriorates and the work is significant.

### SUMMARY

The main object of the invention is to improve the present state of the art.

Another object of the invention is to achieve an improved production method, and related machine to implement it, capable of mitigating the aforementioned problems, in particular capable of coloring or decorating the edges 12b and/or 14b and/or 16b in a more efficient way.

These and other objects are achieved by what is reported in the attached claims; advantageous technical features are defined in the dependent claims.

A furniture item manufactured according to the invention comprises or consists of: a top panel, a bottom panel and two side walls assembled to form a shell delimiting a compartment with an access opening. In particular, the top panel is parallel to the bottom panel and the two side walls are parallel to each other.

The top panel, the bottom panel and the two side walls each have a front edge in the assembled furniture item, and such front edges form the perimeter of the opening and usually have a substantially flat surface. Said furniture item may comprise e.g. also a back wall to close the back of the compartment and/or shelves mounted inside the compartment (such as a shelf 100 in FIG. 1). In particular, one or each shelf is mounted inside said compartment so as to exhibit a front edge 100b (see FIG. 1) inside the perimeter of the opening. That is, the furniture item in the method may also comprise e.g. one or more horizontal shelves mounted inside the compartment orthogonally to—and between—the side walls, and mounted parallel to the top and bottom panel. One or each shelf has a front edge 100b that can be colored according to the method.

Said top panel, bottom panel and side walls may be rectangular panels, and said front edges coincide for example with a lateral rectangular strip of the panel, the strip having as one side the thickness of the panel. In particular, said strip is comprised in a coating layer applied superficially to the edge of the panel.

A method is proposed to finish said furniture item, wherein said surface of the front edges of the top panel, the bottom panel and the side walls is decorated or colored with the steps of:
(i) preferably immobilizing the furniture item, and
(ii) coloring or decorating said surface by running over it—or passing over it—with a printing head to deposit a dye there, e.g. paint or ink.

With the proposed method there is no need any more to customize the single panels, thereby reducing the warehouse stock and limiting the picking operations to the sole dimensional variability of the panel. And advantageously the painting or coloring of the edges can be done on demand on the already assembled furniture item.

In the method, preferably the surface of the front edge of a shelf is colored by running over it—or passing over it—with a printing head to deposit a dye there, e.g. paint or ink. That is, one or each shelf has a front edge which is coloured, before or during the aforementioned step (ii), in the same way as the front edges.

A preferred step of the method envisages coloring the thickness of said coating layer by running over it—or passing over it—with a printing head to deposit a dye there, e.g. paint or ink. In this step the printing head may be the same as in step (ii). The printing head is oriented in space to point it towards the thickness of said coating layer, in particular by rotating the axis of application of the dye by 90° (in FIG. 1 the axis would be orthogonal to the side walls 16-1, 16-2).

In particular, the step of coloring the front edges occurs by sequentially passing a printing head over them to deposit a dye there.

A preferred step of the method envisages that, while the front edges are being colored, the furniture item is manipulated to keep its side walls vertical, in particular also moving forward the furniture item along the line while keeping its side walls vertical. In this way it is possible to shorten the necessary dimensions of the line.

A preferred step of the method envisages depositing the dye by a jet or spray of dye.

A preferred step of the method envisages depositing the dye while keeping the head 2-5 mm away from the front edges, to minimize the dispersion of the dye.

A preferred step of the method envisages that to implement step (i) a side wall of the furniture item is leaned, and made to adhere, against a flat vertical reference surface, with the advantage of minimizing tolerances and printing errors because the flat vertical reference surface mechanically corrects dimensional imperfections of the side wall. A more preferred step of the method envisages the side wall being pulled or pushed towards the flat reference surface, e.g. by suction cups, to improve the correction of dimensional imperfections.

A more preferred step of the method envisages that, before step (ii), the side wall opposite to the one applied to the reference flat surface is pushed towards the reference flat surface, improving the adhesion between the reference flat surface and the side wall, and making the correction of dimensional imperfections more precise.

A more preferred step of the method envisages that before step (ii) the two side walls of the furniture item are placed between two flat vertical reference surfaces parallel to each other, and at least one of the two vertical surfaces is moved and brought closer to the other in order to touch respectively one vertical wall of the furniture and block the two side walls into position between the two flat vertical reference surfaces.

Since the profile of the components making up the furniture is not straight, nor of constant thickness, the printing precision on the assembled furniture item is affected by the tolerances on the single component and those deriving from the assembled components. A more preferred step of the method then envisages that before step (ii) the dimensional tolerances of the reference flat surface are detected, in particular to generate a virtual profile of the reference flat surface.

More specifically, the dimensional tolerances of the reference flat surface are detected by making an optical scan of the reference flat surface and detecting dimensional data that express the deviation of the reference flat surface from an ideal plane.

More preferably, while the printing head moves along a front edge, the dimensional tolerances of the flat reference surface are compensated by moving the printing head, and/or deflecting its dye jet, as a function of said dimensional tolerances, so that the dye is deposited only within the surface of the front edge.

A correction logic may be to move the printing head, and/or deflect its dye jet, toward a direction which is
orthogonal to its advancement direction along such edge, and/or
opposite to a deviation, from an ideal imaginary plane, calculated using said dimensional data.

In this way the positional measurements of the front edge are referred to the reference surface, improving precision.

With the same purpose, preferably, e.g. before or after step (ii), the dimensional tolerances of the front edge to be colored are detected when it is leaned against the reference surface.

Preferably there is a superficial linear slot or groove between the reference surface and the surface of the side wall to be measured, so that the positional detection system more easily identifies the end of the front edge and the beginning of the reference surface.

In particular, the profile of the thickness and/or position of the surface to be printed on the front edge is detected for the entire length of the edge itself.

More preferably, the dimensional tolerances of the front edge to be colored are detected
by making an optical scan of the profile of such front edge detecting dimensional data,
and with such dimensional data a deviation of the profile of the front edge from an imaginary ideal straight line, is calculated.

Preferably, the printing head is guided and/or controlled along one of the front edges by compensating for said deviation.

Even more preferably, the deviation detected on the front edge to be colored is compensated by moving the printing head and/or deflecting its dye jet, while the printing head moves along a front edge, towards a direction which is
orthogonal to its advancement direction along such edge and/or
opposite to said deviation.

Even more preferably, said dimensional tolerances are compensated with the steps of
processing said dimensional data acquired from the scanning of the edge to calculate with said dimensional data a virtual profile of the front edge, and
controlling the printing head as a function of said virtual profile so that the deposit of dye occurs considering the virtual profile as a boundary for the printing, i.e. for example the dye jet is controlled so that it does not come out of the virtual profile towards the outside of the detected front edge.

Preferably before the step of depositing the dye
dimensional tolerances are detected on the flat reference surface and/or the front edge,
a virtual profile of the front edge is generated from the dimensional tolerances, and
to compensate said dimensional tolerances and confine the dye within the perimeter of the front edge, the position of the printing head and/or its dye jet is controlled as a function of the profile so that the dye is deposited on the surface of the front edge considering the profile as a boundary for the printing.

To avoid printing problems beyond the margins or a missed print, it is preferred to precisely locate the beginning and end of the front edge during the scanning process. For this purpose, preferably during the scanning of the extremes of the front edge the acquisition spatial resolution is thickened (e.g. at least every 0.1 mm, i.e. positional data of the front edge are acquired at points distant from each other at most e.g. 0.1 mm) compared to the spatial resolution used during the scanning step of the center of the front edge.

Preferably the flat vertical reference surface is moved together with the furniture item applied to it to bring the furniture item to a workstation where step (ii) takes place.

Preferably the furniture item is loaded on a flat reference surface belonging to a circular series of flat vertical reference surfaces, and
said circular series is rotated angularly to bring the furniture item to each of a circular series of workstations arranged concentrically to the circular series of flat reference surfaces, in particular keeping the side walls of the furniture item always vertical throughout the angular movement.

Preferably, the furniture item is unloaded from the circular series of flat reference surfaces after it has visited all the workstations and the front edges of the furniture item have all been colored.

Preferably, only front edges that are parallel to each other are colored in each of the workstations.

Preferably in one or each of the workstations the front edges on which the dye will then be deposited are cleaned.

Preferably, the dye deposited on the front edges is dried in one or each of the workstations, e.g. via UV irradiation.

Another aspect of the invention concerns a numerical control machine tool for decorating the aforementioned furniture item according to the aforementioned method (see for example FIG. 1), comprising:
a circular (e.g. fixed) series of machining stations;
a table that is
   rotatable about a vertical axis coincident with the center of the circular series of stations,
   provided with a circular series of supports mounted thereon concentrically to the circular series of stations and configured to support the furniture item,
   configured to rotate about said axis to allow each support to sequentially visit each station,
one or each station comprising a movable printing head configured to deposit a dye, e.g. paint or ink, by running over—or passing over—the surface of a front edge.

The circular series of stations may be circumscribed or inscribed (external or internal) in the circular series of supports.

In particular, the circular series of stations and/or the circular series of mounted supports is arranged with polar symmetry, and e.g. with constant angular pitch.

In a preferred variant, one or each station comprises a device for cleaning a front edge before depositing the dye. Such a device is preferably a plasma treatment unit, a detergent applicator unit or a corona effect unit.

In a preferred variant, one or each station comprises a device for drying the dye after it has been deposited on a front edge, preferably a source of UV radiation.

In a more preferred variant, the printing head is controllably mounted orientable on the support so as to be able to direct the dye along a direction parallel to the surface of the front edge to be colored.

In a preferred variant, one or each support is configured to keep the side walls of the furniture item always vertical.

In a more preferred variant, one or each support comprises a flat surface lying in an imaginary vertical plane and configured to make
a side wall of the furniture item lean and adhere against it.

In a more preferred variant, one or each support comprises a first and second flat surface lying in a respective first and second imaginary vertical planes which are parallel to each other, at least one of the first or second flat surface being translatable towards the other flat surface to accommodate the furniture item therebetween and make one side wall lean against respectively each flat surface.

In particular, one or each flat surface comprises means for attracting said side wall, e.g. suction cups or clamps.

In a more preferred variant, one or each support comprises a movable element for pushing the side wall against the first or second flat surface.

In a preferred variant, one or each station comprises a dimensional sensing and measuring device configured to detect a dimension of a front edge and/or an edge of the first or second flat surface. Such device is for example a probing finger, a laser scanner, a single-point laser triangulation measurement sensor, a laser or LED scanning optical micrometer, or an image sensor.

In a preferred variant, the movable printing head and/or the device for cleaning a front edge and/or the device for drying the dye and/or the dimensional detection and measurement device are mounted on a movable member of the support, the movable member being motorized to move at least along two axes within a plane.

In a preferred variant, one or each support comprises a frame or scaffolding comprising two parallel vertical uprights joined by a lower crosspiece and an upper crosspiece, wherein the vertical uprights with the crosspieces form a rectangular or square chassis.

In particular, one or each of said reference surfaces lies on a plane orthogonal to a straight line tangent to a circumference on which the supports are arranged.

In particular, one or each of said stations comprises a frame or scaffolding comprising two parallel vertical uprights and a crosspiece mounted vertically movable on the uprights.

Preferably the calculation and/or processing and/or control operations take place electronically, for example via an electronic processor.

### BRIEF DESCRIPTION OF THE DRAWINGS

Further advantages will be clear from the following description, which refers to a preferred embodiment of machine in which:

FIG. 1 shows a known furniture item;

FIG. 2 shows a plan view of a machine;

FIG. 3 shows a three-dimensional view of a component of the machine in FIG. 2;

FIG. 4 shows a three-dimensional view of another component of the machine in FIG. 2;

FIG. 5 shows a front view of the component in FIG. 4;

FIG. 6 shows a detail of the component in FIG. 3.

### DETAILED DESCRIPTION

Equal numbers in the figures indicate equal or substantially equal parts; to avoid crowding the drawings, sometimes identical elements are not numbered.

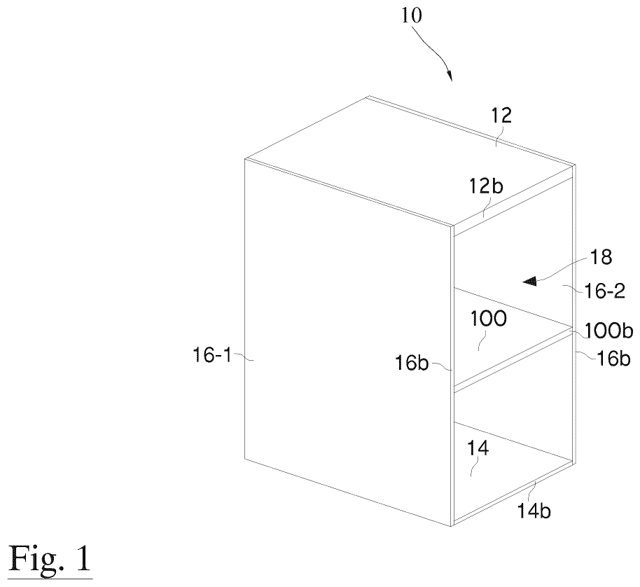

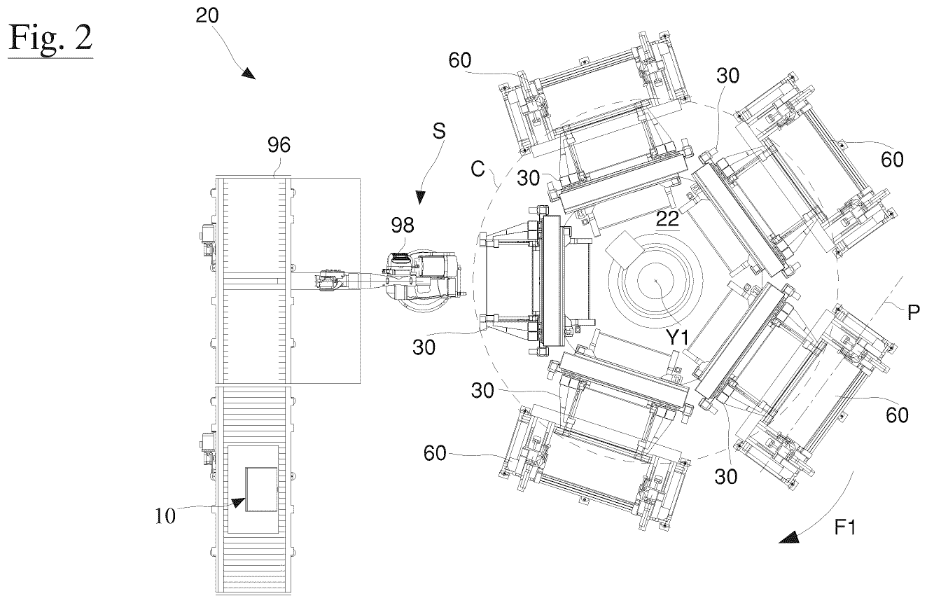

A machine 20 is shown in FIG. 2, and comprises a central rotatable table 22 which is rotatable about an axis Y1—vertical in use—and on which, preferably with polar symmetry, there are mounted supports 30 (in the example there are five supports 30 and for example they are equal). Each support 30 is configured to receive a furniture item to be colored like the furniture item 10 in FIG. 1, wherein zero, one or more shelves 100 may be installed therein.

A plurality of processing stations 60, four in the illustrated example, are arranged in a circular series about the table 22 with an angular pitch equal to that of the supports 30.

The table 22 (see arrow F1) is rotatable in a controlled manner about the Y1 axis to move a furniture item 10 along a circumference C (shown in dashed lines) so that it visits in sequence all the stations 60, where the furniture item 10 stops for a certain time to receive a machining operation.

Preferably, a robot 98 is placed and operates near the space S and is programmed to pick up a furniture item 10 from a line 96, load it onto a support 30 accessible in the space S and unload it from the same support 30 after such support 30 has completed an entire revolution around the table 22 and the furniture item 10 loaded therein has received a coloring on the edges 12b and/or 14b and/or 16b.

A furniture item 10 can also be taken and loaded onto a support 30 manually, or by different means.

Preferably, when the robot 98 is present, so that a space S remains free around the table 22 for loading/unloading a furniture item to be coloured, the following relationship holds:

number of supports 30=(number of stations 60)−1.

Or preferably the relationship holds:
number of stations 60=number of supports 30,
when the loading/unloading of the furniture item takes place in a station 60.

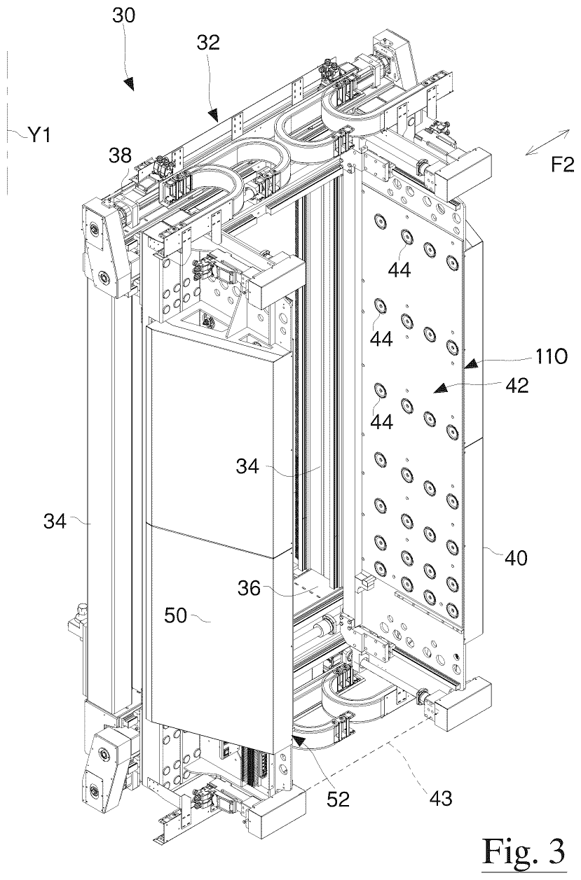

A preferred embodiment of the supports 30 is shown individually in FIG. 3. The support 30 comprises a scaffolding or frame 32 comprising two parallel vertical uprights 34 joined by a lower crosspiece 36 and an upper crosspiece 38. The vertical uprights 34 with the crosspieces 36, 38 form a rectangular or square chassis.

Mounted on the frame or scaffolding 32 are a vertical abutment wall 40, having a flat surface 42, and a pedestal 43 to support the furniture item 10 from below.

The surface 42 lies e.g. on a plane orthogonal to the tangent to the circumference C. The surface 42 is provided with means for holding on it a side panel 16-1 or 16-2, e.g. suction cups 44, pinches or clamps.

Preferably, a second vertical abutment wall 50 is mounted on the frame or scaffolding 32, having a flat surface 52 parallel to and facing the surface 42. More preferably, also the surface 52 is equipped with means for retaining a side panel 16-1 or 16-2 on it, e.g. suction cups, pinches or clamps.

The wall 40 is movable back and forth, via drives 60, with respect to the frame or scaffolding 32, in particular it is movable while remaining parallel to itself, i.e. the wall 40 can translate—see arrow F2—along a direction P parallel to a straight line tangent to the circumference C.

In particular, also the crosspieces 36, 38 are longitudinally oriented parallel to the direction P, and the wall 40 is slidable along, and on, the lower crosspiece 36 and/or the upper crosspiece 38. As will be seen below, such degree of freedom of the wall 40 allows adapting the position of the wall 40 to the width of the furniture item 10 (i.e. the distance between the panels 16-1 and 16-2).

Preferably also the wall 50 is movable like the wall 40, and more preferably with the same mechanisms and same orientation. Therefore the two walls 40, 50 can move closer or further apart from each other, remaining parallel to each other, to clamp the furniture item 10 therebetween; each of the two walls 40 contacts one of the two panels 16-1, 16-2.

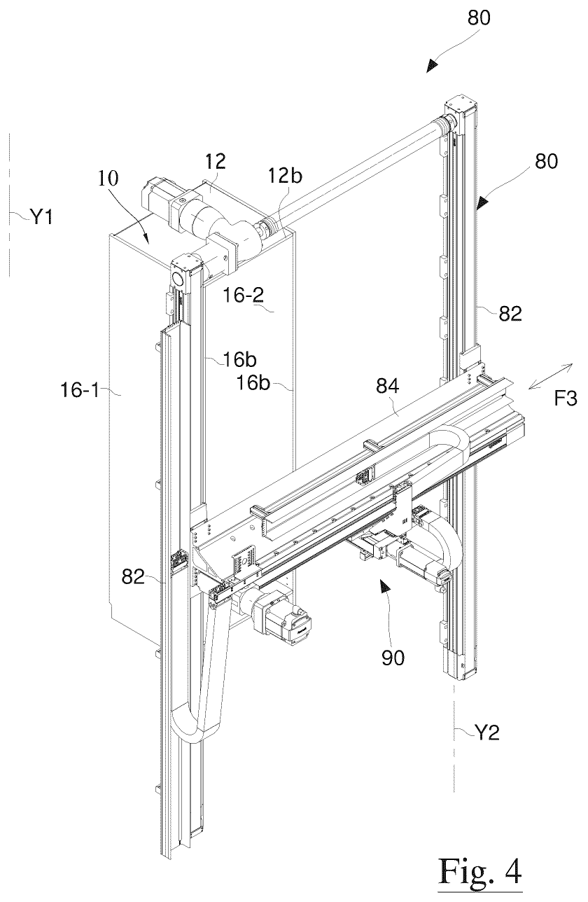

One embodiment for the stations 60 is shown individually in FIG. 4.

The station 60 comprises a scaffolding or frame 80 formed of two parallel vertical uprights 82 and a crosspiece 84 mounted movable vertically on the uprights 82. The crosspiece 84 is movable along an axis Y2 parallel to the axis Y1.

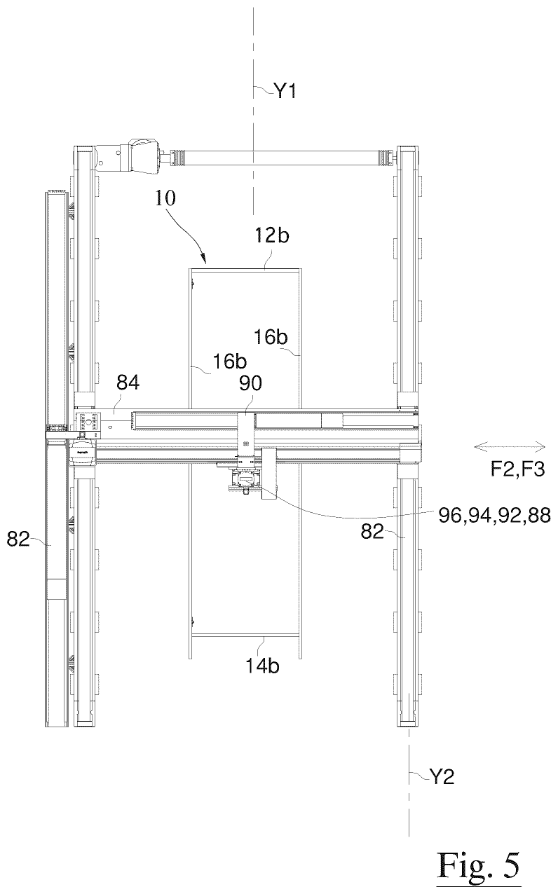

By known drives 70, on the crosspiece 84 is mounted linearly translatable (see direction F3 parallel to the arrow F2) a trolley 90 (see FIG. 5) equipped with:
a printing head 96 e.g. an inkjet head, and/or
a dimensional detection and measurement device 94, and/or
pre-curing device 92, e.g. a UV radiation emitting device (it may be integrated, or set alongside, with the printing head), and/or
a cleaning device 88.

The pre-curing device 92 acts after the printing and preferably emits UV radiation on the printed surface to cross-link the dye and bring it into a condition to be handled without leaving fingerprints thereon.

Since often the dye is ready only when a time necessary for complete drying has lapsed, it is preferred to arrange on the last station 60 of the machine 20 (before unloading) an analogous curing device dedicated to the complete cross-linking.

The cleaning device 88 is preferably provided in the first station 60 of the machine 20 along the direction of angular advancement (along the circumference C), and preferably is a plasma treatment system and/or a unit for the application of detergent. If the edges 12b, 14b, 16b, 100b are strips glued onto semi-finished panels, they are often made of polymeric material, such as PVC and ABS, and arrive from the production line without having undergone surface and/or cleaning treatments. There may be organic residues, derived from the production process or from the manipulation of the edges 12b, 14b and 16b, which would lead to poor adhesion of the printing dye and unacceptable final quality. Plasma treatment of a PVC surface to be colored has been found to improve dye adhesion because it increases the surface energy of the material itself. The distribution of the dye is improved too. Furthermore, the intense flow of ions directed toward the front edge removes the organic residues from the surface and allows for an excellent level of cleanliness, an ideal condition for printing and coating processes.

The cleaning device 88 may also be a corona effect system. The purpose of surface treatment on polymeric materials is to increase surface wettability through an electrical discharge, since the low surface energy of polymeric substrates often leads to poor adhesion of inks, glues and paints. To obtain an optimal adhesion, the surface energy between the upper substrate and that of the material to be applied is then increased.

The provision of the trolley 90 at each station 60 depends on the angular position of that station 60 along the circumference C.

E.g. in the illustrated case of four stations 60, clockwise in FIG. 2, we have that:
the trolley 90 of the first station 60 is equipped with a cleaning device 88;
the trolley 90 of the second station 60 is equipped with a printing head 96, a dimensional detection and measurement device 94, and a drying device 92;
the trolley 90 of the third station 60 is equipped with a printing head 96, a dimensional detection and measurement device 94, and a drying device 92; and the trolley 90 of the fourth station 60 is equipped with a drying device 92.

### Operation

The overall operation of the machine 20 occurs with the following preferred sequence:
(i) a furniture item 10 arrives assembled, e.g. on the line 96, spatially oriented as it would be in use, i.e. with the panels 16 placed vertically and the panels 12, 14 horizontal;
(ii) the furniture item 10 is picked up for example by the robot 98 or a human operator and placed on the support 30 present in the space S (defined here as support 30*). On the support 30*, throughout the entire travel on the table 22, the furniture item 10 always remains spatially oriented as it would be in use, i.e. with the panels 16 positioned vertically;
(iii) the furniture item 10 is placed on the support 30 by placing the external surface of a side panel, e.g. the panel 16-1, in contact with the flat surface 42, on which the means for holding are then activated, thereby obtaining permanent adhesion between the panel 16-1 and the flat surface 42.

If on the support 30 there is the second vertical abutment wall 50, the flat surface 52 is moved away from the surface 42 more than the distance between the panels 16-1, 16-2 (the width of the furniture item 10) to facilitate the assembly of the furniture item 10 on the support 30*; after which the flat surface 52 is brought closer to the surface 42 until it touches the other panel 16-2 to clamp the furniture item 10 between the surfaces 42, 52;
(iv) the table 22, which always rotates in the same direction (clockwise in FIG. 2), rotates and the support 30* arrives at the first station 60. Here the respective trolley 90 and crosspiece 84 are operated so that the cleaning device 88 is placed in front of the edges 12b, 14b, 16b (and 100b if present) and sweeps their length to clean them. The cleaning device 88 travels having as a trajectory e.g. the perimeter of a square or rectangle;
(v) the table 22 rotates and the support 30* with the furniture item 10 arrives at the second station 60. The relative trolley 90 and the crosspiece 84 are operated so that the detection device 94 is positioned in front of the edges 16b and in sequence runs along them vertically in the lengthwise direction to scan the profile thereof and acquire the relative dimensional deviation compared to a perfectly flat ideal panel. Then the trolley 90 and the crossbar 84 are operated so that the printing head 96 is positioned in front of the edges 16b. Then in sequence the printing head 96 runs along the edges 16b lengthwise and deposits a dye on them. The jet of dye and/or the head 96 are controlled so that the deposited dye does not go beyond the scanned profile towards the outside of the edge 16b (in practice the scanned profile is used as a variable margin of printing);
(vi) the table 22 rotates and the support 30* brings the furniture item 10 to the third station 60. The related trolley 90 and the crosspiece 84 are operated so that the sensing device 94 is positioned in front of the edges 12b and 14b, and sequentially runs along them horizontally in the direction of their length to scan their profile and acquire the relative dimensional deviation compared to a perfectly flat ideal panel. Then the trolley 90 and the crossbar 84 are operated so that the printing head 96 is positioned in front of the edges 12b and 14b, and sequentially runs along them horizontally in the direction of their length to deposit a dye on them with the same logic as step (v);
(vii) the table 22 rotates and the support 30* brings the furniture item 10 to the fourth station 60. The related trolley 90 and the crosspiece 84 are operated so that the drying device 92 is positioned in front of the edges 12b, 14b and 16b, and sequentially travels along them lengthwise to dry the dye present there;
(viii) finally, the table 22 rotates and the support 30* brings the furniture item 10 back to the space S, where it is unloaded for example by the robot 98; and the cycle starts again with another furniture item 10.

If shelves 100 are present, in the aforementioned steps the relative edges 100b are treated similarly.

The number of stations on the table 22 may vary. Considering that such number is inversely proportional to the cycle time, the greater the cycle time, the lower the preferred number of stations, as more operations can be performed on the same station.

According to the desired cycle time it is possible to reduce the number of stations of the table 22 by incorporating more operations in the same station.

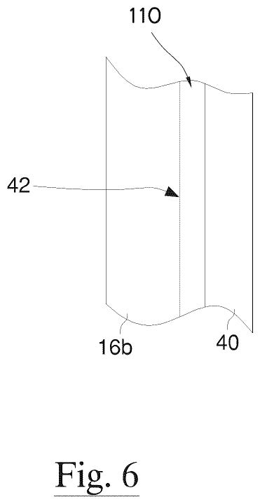

To improve the acquisition of the profile of the front edge to be colored, preferably the wall 40 is structured so that an empty groove 110 remains between the surface 42 and the side wall 16b which rests on it (FIG. 6). The groove 110 allows the surface 42 to be clearly separated from the side wall 16b, so the detection device 94 is better able to distinguish them.

The sensing device 94 may be a probing finger, a laser scanner, a single point laser triangulation measurement sensor, a laser or LED scanning optical micrometer, or an image sensor.

1. Method for finishing a furniture item comprising or consisting of: a top panel, a bottom panel, and two side walls assembled to form a shell delimiting a compartment with an access opening; the top panel, the bottom panel, and the two side walls each having a front edge in the assembled furniture item, such front edges forming the perimeter of the opening and having a substantially flat surface;
wherein said surface of the front edges of the top panel, bottom panel, and side walls are decorated or colored by running over it—or passing over it—with a printing head to deposit a dye there.

2. Method according to claim 1, wherein while the front edges are being colored, the furniture item is manipulated to keep its side walls vertical.

3. Method according to claim 1, wherein prior to said step of depositing the dye, a side wall of the furniture item is leaned and made to adhere against a flat vertical reference surface.

4. Method according to claim 3, wherein the side wall is drawn or pushed toward the flat reference surface.

5. Method according to claim 3, wherein prior to the step of depositing the dye
dimensional tolerances of the reference flat surface are detected,
a virtual profile of the front edge is generated from the dimensional tolerances, and
to compensate for said dimensional tolerances and confine the dye within the perimeter of the front edge, the position of the printing head and/or a dye jet thereof are controlled as a function of the profile so that the dye is deposited on the surface of the front edge considering the profile as a boundary for the printing.

6. Method according to claim 3, wherein prior to the step of depositing the dye
dimensional tolerances of the front edge are detected,
a virtual profile of the front edge is generated from the dimensional tolerances, and
in order to compensate for said dimensional tolerances and confine the dye within the perimeter of the front edge, the position of the printing head and/or a dye jet thereof are controlled as a function of the profile so that the dye is deposited on the surface of the front edge considering the profile as a boundary for the printing.

7. Numerical control machine tool for decorating a furniture item according to the method of claim 1, comprising:
a circular series of machining stations;
a table that is
rotatable about a vertical axis coincident with the center of the circular series of stations,
provided with a circular series of supports mounted on it concentrically to the circular series of stations and configured to support the furniture item,
configured to rotate about said axis to allow each support to sequentially visit each station,
one or each station comprising a movable printing head configured to deposit a dye by running over—or passing over—the surface of a front edge.

8. Machine according to claim 7, wherein one or each support comprises a flat surface lying in an imaginary vertical plane and configured to make a side wall of the furniture item adhere thereto.

9. Machine according to claim 7, wherein one or each station comprises a dimensional sensing and measuring device configured to detect a profile of a front edge and/or an edge of the flat surface.

10. Machine according to claim 8, wherein the flat surface comprises means for attracting said side wall.

11. Method according to claim 2, wherein prior to said step of depositing the dye, a side wall of the furniture item is leaned and made to adhere against a flat vertical reference surface.

12. Method according to claim 11, wherein the side wall is drawn or pushed toward the flat reference surface.

13. Method according to claim 4, wherein prior to the step of depositing the dye
dimensional tolerances of the reference flat surface are detected,
a virtual profile of the front edge is generated from the dimensional tolerances, and
to compensate for said dimensional tolerances and confine the dye within the perimeter of the front edge, the position of the printing head and/or a dye jet thereof are controlled as a function of the profile so that the dye is deposited on the surface of the front edge considering the profile as a boundary for the printing.

14. Method according to claim 4, wherein prior to the step of depositing the dye
dimensional tolerances of the front edge are detected,
a virtual profile of the front edge is generated from the dimensional tolerances, and
in order to compensate for said dimensional tolerances and confine the dye within the perimeter of the front edge, the position of the printing head and/or a dye jet thereof are controlled as a function of the profile so that the dye is deposited on the surface of the front edge considering the profile as a boundary for the printing.

15. Method according to claim 5, wherein prior to the step of depositing the dye
dimensional tolerances of the front edge are detected,
a virtual profile of the front edge is generated from the dimensional tolerances, and
in order to compensate for said dimensional tolerances and confine the dye within the perimeter of the front edge, the position of the printing head and/or a dye jet thereof are controlled as a function of the profile so that the dye is deposited on the surface of the front edge considering the profile as a boundary for the printing.

16. Machine according to claim 8, wherein one or each station comprises a dimensional sensing and measuring device configured to detect a profile of a front edge and/or an edge of the flat surface.

17. Machine according to claim 9, wherein the flat surface comprises means for attracting said side wall.
